(19) United States
(12) Patent Application Publication
(10) Pub. No.: US 2013/0007063 A1
(43) Pub. Date: Jan. 3, 2013

(54) METHOD AND APPARATUS FOR REAL-TIME PROCESSING OF DATA ITEMS

(75) Inventors: Pavandeep Kalra, Shrewsbury, MA (US); Sergery Boldyrev, Soderkulla (FI)

(73) Assignee: Nokia Corporation, Espoo (FI)

(21) Appl. No.: 13/538,810

(22) Filed: Jun. 29, 2012

Related U.S. Application Data
(60) Provisional application No. 61/503,315, filed on Jun. 30, 2011.

(51) Int. Cl. G06F 17/30

(52) U.S. Cl. 707/796; 707/E17.005

(57) ABSTRACT

An approach is provided for facilitating real-time execution of computations of data based on context information upon collection, storage, retrieval or use of the data. A data analysis platform determines context information associated with one or more data items stored at one or more nodes. It also determines one or more computations for processing the one or more data items based on the context information. A serialization of the one or more computations or corresponding context information is associated with the one or more data items for processing by the one or more nodes.

### RELATED APPLICATIONS

This application claims benefit of the earlier filing date under 35 U.S.C. §119(e) of U.S. Provisional Application Ser. No. 61/503,315 filed Jun. 30, 2011, entitled “Method and Apparatus for Real-Time Processing of Data Items,” the entirety of which is incorporated herein by reference.

### BACKGROUND

Today's Internet ready wireless communication devices such as mobile phones, personal data assistants (PDAs), laptop computers and the like, make on-demand access to information convenient for users. As the demand for data grows, so does the need for effective management and processing of data of various types, especially in distributed or cloud based networking environments where multiple communication devices may interact to share, collect and analyze information. A particular means of facilitating such interaction is through the use of computation closure processing techniques, wherein the devices are caused to operate upon the data using only the most basic or primitive processes (e.g., computation closures) required. A particular advantage of this approach is that data can be migrated to the closest possible computation level across the distributed computing environment with minimized or improved cost, energy consumption, security enforcement requirements, privacy regulation, etc.

The type of data capable of being shared, collected and retrieved among interacting devices may include binary data which is typically raw in form, structured data that corresponds to specific file formats or semantics, or combinations thereof. Typically, the data must be retrieved from respective data sources, including the interacting devices or cloud computing sources, in its particular form then stored for subsequent processing. Given the varying requirements and complexities of processing data of different types, however, there is currently no means of facilitating real-time analysis of the data to support context specific execution of the data within a distributed computing environment.

### SOME EXAMPLE EMBODIMENTS

Therefore, there is a need for an approach for facilitating real-time execution of computations of data based on context information upon collection, storage, retrieval or use of the data.

According to one embodiment, a method comprises determining context information associated with one or more data items stored at one or more nodes. The method also comprises determining one or more computations for processing the one or more data items based, at least in part, on the context information. The method also comprises causing, at least in part, a serialization of the one or more computations, the context information, or a combination thereof. The method further comprises determining to associate the serialization with the one or more data items.

According to another embodiment, an apparatus comprises at least one processor, and at least one memory including computer program code for one or more computer programs, the at least one memory and the computer program code configured to, with the at least one processor, cause, at least in part, the apparatus to determine context information associated with one or more data items stored at one or more nodes. The apparatus is also caused to determine one or more computations for processing the one or more data items based, at least in part, on the context information. The apparatus is also caused to cause, at least in part, a serialization of the one or more computations, the context information, or a combination thereof. The apparatus is further caused to determine to associate the serialization with the one or more data items.

According to another embodiment, a computer-readable storage medium carries one or more sequences of one or more instructions which, when executed by one or more processors, cause, at least in part, an apparatus to determine context information associated with one or more data items stored at one or more node. The apparatus is also caused to determine one or more computations for processing the one or more data items based, at least in part, on the context information. The apparatus is also caused to cause, at least in part, a serialization of the one or more computations, the context information, or a combination thereof. The apparatus is further caused to determine to associate the serialization with the one or more data items.

According to another embodiment, an apparatus comprises means for determining context information associated with one or more data items stored at one or more nodes. The apparatus also comprises means for determining one or more computations for processing the one or more data items based, at least in part, on the context information. The apparatus also comprises means for causing, at least in part, a serialization of the one or more computations, the context information, or a combination thereof. The apparatus further comprises means for determining to associate the serialization with the one or more data items.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of facilitating real-time execution of computations of data based on context information upon collection, storage, retrieval or use of the data, according to one embodiment;

FIG. 2A is a diagram of the components of a data analysis platform, according to one embodiment;

FIG. 2B is a diagram of a closure processing module of the data analysis platform, according to one embodiment;

FIGS. 3A and 3B are diagrams depicting a functional flow of computation closures as distributed across nodes, according to various embodiments;

FIGS. 4A and 4B are flowcharts of a process for facilitating real-time execution of computations of data based on context information upon collection, storage, retrieval or use of the data, according to various embodiments;

FIGS. 5A-5D are diagrams of user interfaces utilized in the processes of FIGS. 3A and 3B, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for facilitating real-time execution of computations of data based on context information upon collection, storage, retrieval or use of the data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to reflective or granular process computing, it is contemplated that the approach described herein may be used with other computation systems and architectures as well. This includes information space architectures, smart space architectures, cloud-based computing architectures, or combinations thereof. An information space, smart space or cloud may include, for example, any computing environment for enabling the sharing of aggregated data items and computation closures from different sources among one or more nodes. This multi-sourcing is very flexible since it accounts and relies on the observation that the same piece of information can come from different sources. For example, the same information (e.g., image data) can appear in the same information space from multiple sources (e.g., a locally stored contacts database, a social networking directory, etc.). In one embodiment, information and computations of data within the information space, smart space or cloud is represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It represents a general method for conceptual description or modeling of information that is implemented in web resources; using a variety of syntax formats.

Computation closures, by way of example, may include any data computation procedure together with relations and communications among interacting nodes within the information space, smart space, cloud or combination thereof, for passing arguments, sharing process results, selecting results provided from computation of alternative inputs, flow of data and process results, etc. The computation closures (e.g., a granular reflective set of instructions, data, and/or related execution context or state) provide the capability of slicing of computations for processes and transmitting the computation slices between nodes, infrastructures and data sources. Also, reflective computing may include, for example, any capabilities, features or procedures by which the smart space, information space, cloud or combination thereof permits interacting nodes to reflect upon their behavior as they interact and actively adapt. Reflection enables both inspection and adaptation of systems (e.g., nodes) and processed at run time. While inspection allows the current state of the system to be observed, adaptation allows the system's behavior to be altered at run time to better meet the processing needs at the time.

Typically, reflective computing is a convenient means to enable adaptive processing to be performed respective to the contextual, environment, functional or semantic conditions present within the system at the moment. Furthermore, it is particularly useful for systems destined for operation within a distributed computing environment (e.g., cloud based environment) for executing computation. The cloud provides access to distributed computations for various devices within the scope of the cloud, in such a way that the distributed nature of the computations is hidden from users and it appears to a user as if all the computations are performed on the same device. The cloud computing also enables a user to have control over computation distribution by transferring computations between devices that the user has access to. For example, a user may want to transfer computations among work devices, home devices, and portable devices, other private and public devices, etc. Current technologies enable a user of a mobile device to manipulate contexts such as data and information via the elements of a user interface of their user equipment.

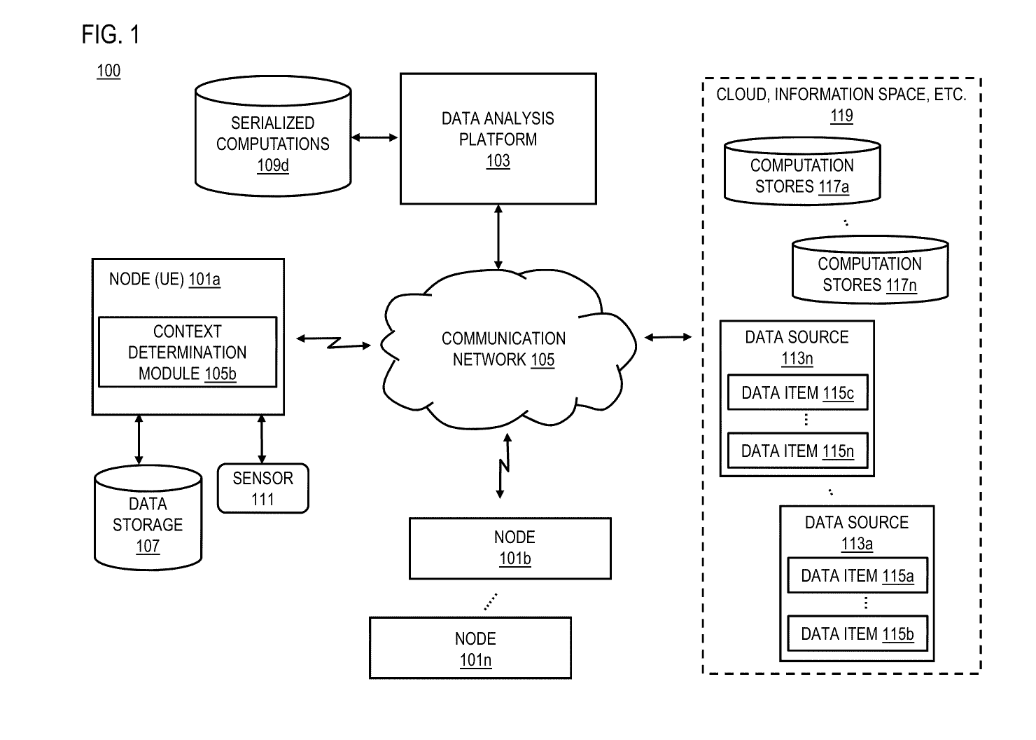

FIG. 1 is a diagram of a system capable of facilitating real-time execution of computations of data based on context information upon collection, storage, retrieval or use of the data, according to one embodiment. For the purpose of example, the system 100 is presented from the perspective of a distributed computing environment, wherein one or more nodes 101a-101n may interact with various data sources 113a-113n, computation stores 117a-117n, and other components and/or systems of a cloud, information space or smart space infrastructure 119. By way of example, the system 100 is configured to enable a serialization of one or more computations for processing of data items to be associated with the data items concurrent with or substantially in real-time with accessing of the data items. As such, when a node 101—i.e., a physical, virtual or software device operating within the distributed environment—attempts to collect, store, retrieve or otherwise use the data items, an associated serialization of the one or more computations is executed as well. The data items 115a-115n may be accessed from various data sources 113, including other nodes as well as from various databases, data servers, data feeds, content delivery systems, application servers and other sources by way of a supporting communication network. The computation stores 117 maintain various computations generated based on the execution of computation closures for said data items 115a-115n.

The type of data items required to fulfill a request within the distributed computing environment will vary depending on the task or process to be carried out by the requesting node(s). For example, some data items 115 may be procured from the cloud 119 in binary form wherein the data is more raw and unstructured in nature. Binary (unstructured) data cannot be readily decomposed into standard components—i.e., image data may consist of a long stream of 1s and 0s but cannot be broken down into any finer structure for facilitating streamlined database storage. As another example, data items 115 may be structured in form wherein the data corresponds to a particular file format, syntax, schema or semantics—i.e., document data may consist of elements for processing by a word processing application. Still further, in other instances, the data items may be a combination of binary and structured data. It is noted that typically, unstructured is larger in size and less suited for replication across nodes in a distributed environment, while structured data is smaller and more readily shared amongst nodes.

Currently, nodes 101 process data items of various forms by retrieving the data from one or more sources, storing it to a data store (e.g., cache), then later performing any processing and/or analysis of the data. Moreover, the data analytics, search capability or other processing of the data requires the use of separate application programming interfaces (APIs) for the various nodes requiring access to the data. This creates application and system complexity given that the data items must be managed by disparate systems given the varying node capabilities. Furthermore, the delay in processing of the data items from the moment of accessing of the data (e.g., retrieval, collection) minimizes the effective momentary use of the data for facilitating real-time, context specific tasks by requesting nodes. The lack of ability of nodes 101 to immediately determine and exploit information regarding the context for which the data is being accessed prohibits integrated/concurrent storage and analytics processing.

Still further, the differing granularity of data items 115 due to its varying forms (binary, structured, semi-structured) limits the ability of interacting nodes to facilitate scalable, contextually rich information processing within a heterogeneous, distributed networking environments (e.g., a cloud 119). Hence, there is currently no means for enabling granular and reflective context analysis and corresponding computational balancing capability for supporting nodes 101, including back end systems, as they interact with various data sources—i.e., private cloud to public cloud networks.

To address these issues, a system 100 of FIG. 1 introduces the capability to associate a serialization of one or more computations for processing the one or more data items 115a-115n with the data items 115a-115n. By way of example, one or more nodes, or user equipment (UE) 101a-101n interact with one another over a distributed communication network 105 via a data analysis platform 103 to execute the one or more computations in serialized form. Computations are maintained within an information space, cloud, smart space, etc., 119 in one or more computation stores 117a-117n, pursuant to the execution of one or more computation closures. Serialized versions of said computations are maintained in a serialized computation database 109d by the data analysis platform 103 for access by the various nodes 101. As such, computations may be executed by the one or more nodes directly in connection with, or at the time of, access of the data items 115a-115n; thus limiting or eliminating any delay between retrieval, storage and use of the data items 115a-115n for supporting context specific tasks. Context specific tasks may include, for example, any application, service, device and/or user oriented tasks to be carried out in relation to the interaction of one or more users, the one or more nodes (UE) 101a-101n, or a combination thereof over the communication network 105. The tasks may also involve the execution of the one or more computations 109d associated with the various data items 115a-115n.

In certain embodiments, context information may be detected or gathered respective one or more users, one or more nodes, one or more data sources, or a combination thereof for indicating or representing a particular business, social, situational or environmental context. A context determination module 105b may be configured to operate in connection with one or more sensors of the node for detecting and/or gathering context information. By way of example, context information may be sensed by way of a location/geo-spatial detection sensor, motion sensor, position sensor, various time tensors, temperature sensor, etc. The context determination module 105b may also be configured to interact with the data analysis platform 103 for receiving context information based on the execution of one or more computations 109d (as serialized). Processing tasks to be carried out amongst the one or more nodes 101a-101n based on context information may include for example:

1. Real-Time Predictive Pattern Recognition for Traffic Data:
In this exemplary context, data items 115a-115n are obtained from various traffic related data feeds/sources 113a-113n (e.g., accident data, road condition data, event data, weather data, etc., be it current and/or historical). Real-time processing of the data items 115a-115n may be performed concurrent with accessing of the data to predict that traffic conditions will deteriorate in the next 30 minutes. Processing is facilitated by way of computation closure processing of the data items 115a-115n, including analyzing the data items based on various traffic and/or route mapping algorithms, with the resulting computations being based in part on context information. The context information may be that for indicating a historical peak traffic time along a given route, data for indicating it is currently a Friday afternoon, an average and/or current speed of travel for a particular user, etc.

2. Real-Time Music Recommendations for Social Networking Engagement:
In this exemplary context, data items 115a-115n are obtained from a music related and/or social networking related data sources 113a-113n (e.g., user profile information, music preference data, etc., be it current and/or historical). Real-time processing of the data items 115a-115n may be performed concurrent with accessing of the data to generate recommendations about music a user of a node (e.g., a mobile device) should listen to. Processing is facilitated by way of computation closure processing of the data items 115a-115n, including gathering current data about others in the social network of the user, with the resulting computations being based in part on context information. The context information may be that for indicating what music others in the user's social network are listening to at the current moment, current activities engaged by the users of others in the social network, the location of other nodes with respect to the user (e.g., automatically trigger execution of a particular love song in response to the detection of a spouse), etc.

3. Real-Time Pattern Recognition for Tag Generation:

In this exemplary context, data items 115a-115n are obtained from an image repository or social networking related data sources 113a-113n (e.g., user profile information, image data, etc., be it current and/or historical). Real-time processing of the data items 115a-115n may be performed, including pattern recognition processing, concurrent with accessing of the data to generate recommendations about tags to associate with the image data for association with a social networking site. Processing is facilitated by way of computation closure processing of the data items 115a-115n, with the resulting computations being based in part on context information for indicating what patterns are determined from the images, tags provided by others corresponding to others in the social network of a user, current location information for the user and others in the user's social network, etc.

4. Real-Time Pattern Recognition for Informational Resource Recommendations:

In this exemplary context, data items 115a-115n are obtained from a marketing data source, travel site, geo-location data provider or mapping data source 113a-113n (e.g., location information, promotional/product data, etc., be it current and/or historical). In addition, one or more nodes (e.g., mobile devices) may capture images by way of an integrated camera. Real-time processing of the data items 115a-115n may be performed concurrent with accessing of the data, including pattern recognition processing and location information analysis, to compile information associated with the captured image data. Processing is facilitated by way of computation closure processing of the data items 115a-115n, with the resulting computations being based in part on context information for indicating what patterns are determined from the images, current location information for the user, etc. By way of example, an image of a movie poster as captured by a node can be processed to generate a recommendation on where the movie is playing relative to the current location of the node.

In examples 1 and 2 above, the context and associated processing tasks as described may be performed respective to structured data items. Structured data may include, for example, a document or file corresponding to a predetermined format, image or audio data corresponding to a predetermined format, etc. In examples 3 and 4, the context and associated processing task as described may be performed respective to binary and/or unstructured data item. Binary and/or unstructured data items may include, for example, text, graphic images, still video clips, full motion video, sound waveform data, etc. It is noted that the accessing of data items by one or more nodes 101a-101n within the distributed environment may include, for example, the retrieval or collecting of data items 115a-115n from one or more data sources 113a-113n, storing of the data by a respective node 101 to local storage 107, or use of the data relative to a given serialized computation 109d of the data items 115a-115n; any of which trigger processing of the data items 115a-115n or the associated serialization at substantially the same time as the accessing by a data analysis platform 103.

In certain embodiments, the data analysis platform 103 determines one or more computations for processing the one or more data items 115a-115n based on the context information by way of computation closure processing. The computation closures (e.g., a granular reflective set of instructions, data, and/or related execution context or state) provide the capability of slicing of computations for processes and transmitting the computation slices between devices, infrastructures and information sources. It is noted that computation closure processing effectively economizes resource usage, data sharing, power consumption, etc., to enable substantially real-time processing of data items upon access.

The data analysis platform 103 also operates in connection with the one or more nodes 101a-101n to generate the serialization as the data items 115a-115n are accessed from the data sources 113a-113n. In certain embodiments, the serialization process entails the conversion of the one or more computations—i.e., the resulting output of one or more computation closures relative to one or more data items—into a format, syntax or metadata structure suitable for being appended to, attached to or associated with the data items 115a-115n for processing by the one or more nodes 101a-101b. By way of example, when a data item 115a corresponds to spreadsheet data of a known (structured) format, the computation of the corresponding data items 115a is serialized in accordance with said format. Likewise, when a data item 115n corresponds to audio data in binary form, the computation of the corresponding data item 115n is serialized accordingly. It is noted that the serialization of the one or more computations 109d of the one or more data items 115a-115n is executed in accordance with a format common to the one or more nodes 101a-101n requiring access to the data items 115a-115n. Hence, the serialization of a given data item 115 may be customized to accommodate different node processing, service and application processing requirements.

As shown in FIG. 1, the system 100 comprises one or more nodes, or user equipment (UE) 101 having connectivity to the data analysis platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, data sources 113 and data analysis platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

The data analysis platform 103 is configured to process data items 115a-115n in association with the related serialization of one or more computations, substantially concurrent with the retrieval, collection, storage or use of the data items by the various nodes 101a-101n. In certain embodiments, the data analysis platform 103 may be a hosted solution, wherein the various nodes subscribe with the host to engage the platform 103, engage over the smart space or information space, access the cloud, or a combination thereof. Although depicted as a separate entity, it is contemplated that the data analysis platform 103 may be implemented for direct operation by respective UEs, i.e., nodes 101a-101n. As such, the data analysis platform 103 may generate direct signal inputs at the nodes for performing the above described serialization, association and data processing tasks within the distributed computing environment.

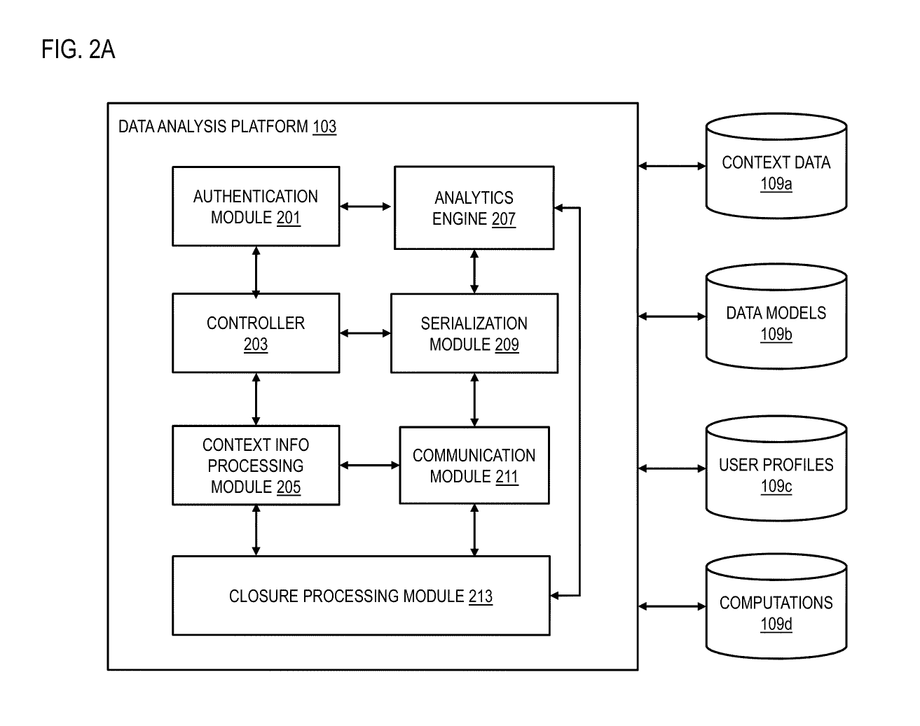

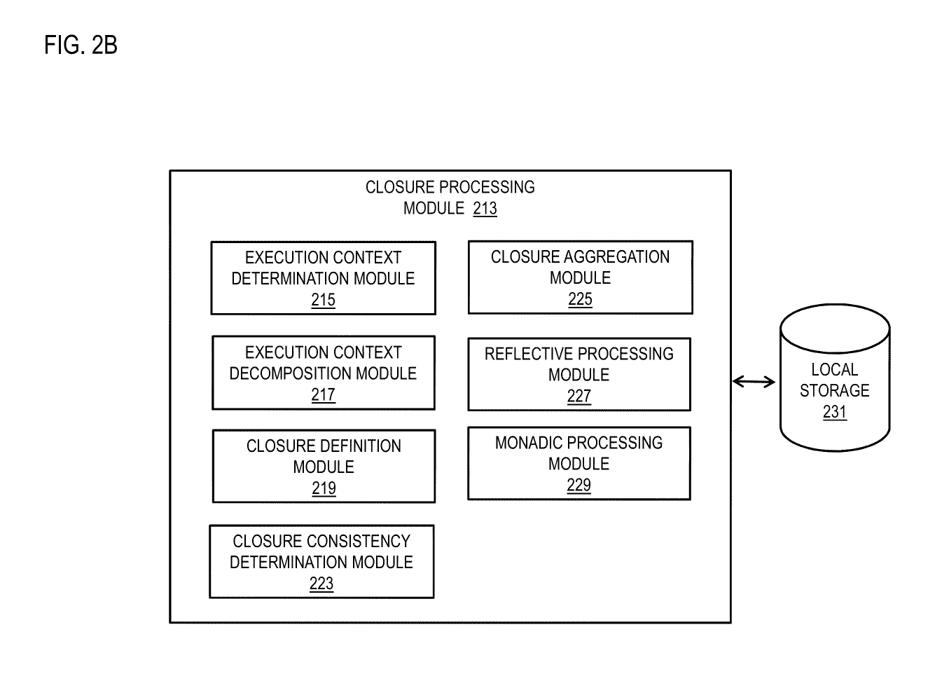

FIG. 2A is a diagram of the components of a data analysis platform, according to one embodiment, according to one embodiment. By way of example, data analysis platform 103 includes one or more components for facilitating real-time execution of computations of data based on context information upon collection, storage, retrieval or use of the data. Furthermore, the data analysis module may support or facilitate computation closure processing and interaction among the various nodes 101 over the communication network 105. It is contemplated that the functions of these components may be combined in one or more components or performed by other components of equivalent functionality.

In this embodiment, the data analysis platform 103 includes an authentication module 201, a controller 203, a context information processing module 205, an analytics engine 207, a serialization module 209, a communication module 211 and a closure processing module 213. The data analysis platform 103 also maintains and accesses various data stores, including a context database 109a for maintaining context information as collected, retrieved or detected by the context information processing module and/or respective nodes 101. Also, a data model database 109b is maintained for storing one or more context based models or computation closure processing models by which the one or more data items are to be processed relative to a given context. A user profile database 109c is also maintained for storing distributed network and/or data analysis platform subscribers, as facilitated by way of the authentication module 201. Still further, the one or more serialized computations to be associated with the various data items as retrieved from various sources is also maintained in a computation database 109d.

In one embodiment, the context information processing module 205 utilizes one or more data models 109b to analyze, interpret and otherwise process the context information as captured by a respective node or conveyed by a particular data source. By way of example, the context information processing module 205 may receive context information pertaining to speed data and correlate this data with a particular requesting node (or application thereof) to traffic data processing. Resultantly, the module 205 acquires various traffic data processing models pertaining to the requesting node (or calling application thereof) for performing context determination accordingly. It is noted that the context information processing module 205 may operate in lieu of a context determination module 105b at a respective node. Under this scenario, the module 205 may process the sensor data collected by the various nodes directly. Alternatively, the module 205 may receive data as preprocessed by a context determination module 105b at a respective node.

In certain embodiments, the analytics engine 207 performs analysis of the one or more data items as received from one or more data sources based, at least in part, on the context information. By way of example, the analytics engine 207 interacts with a given node to determine the following analysis criteria relative to the context:
what data items needs to be persisted (e.g., which data items are most relevant to the given context and/or associated processing task);
what data items need to be available for processing (e.g., across computation closures processes);
the time or work flow criticality of the data that needs to be analyzed; and
the specific object models and corresponding context models to be used for facilitating processing of the data items.

In addition, the analytics engine 207 is configured to procure the data needed by complex querying and data mining operations. By way of example, when data items are accessed from various data sources, the analytics engine 207 performs the necessary querying or filtering of the data best suited for supporting a given context based on the determined criteria. This may include, for example, applying the object models and context and rules of processing to the data items. Still further, the analytics engine 207 may operate in connection with a computation closure processing module 213 to ensure the updating of corresponding data items, as queried, filtered or otherwise processed relative to a given processing task, in all places where it needs to be available for consumption. By way of example, when a particular data item is determined based on the criteria, as no longer needed for processing, this data item is deleted. Resultantly, the analytics engine 207 ensures that the deletion is carried out across all the structures where it is stored internally, thus ensuring consistency of computations.

The analytics engine 207 also associates a serialized version of a computation with one or more data items pursuant to processing of the one or more data items by the analytics engine 207 and/or closure processing module 213. The serialization module 209 utilizes the defined closures and produces the serialized granular computation elements. In addition, the analytics engine 207 can also perform data marshalling as is necessary for ensuring data format consistency within a distributed environment. By way of example, the computations may be serialized in a format, syntax or metadata structure suitable for being appended to, attached to or associated with the data items. Hence, the serialization module 209 ensures the format corresponds to the particular node 101 that is to receive the computation. Pursuant to the serialization process, the processing state of each closure is also encoded and stored in the computation space accordingly.

In one embodiment, the closure serialization may be generated and stored using Resource Description Framework (RDF) format. RDF is a family of World Wide Web Consortium (W3C) specifications originally designed as a metadata data model. It has come to be used as a general method for conceptual description or modeling of information that is implemented in web resources; using a variety of syntax formats. The underlying structure of any expression in RDF is a collection of triples, each consisting of three disjoint sets of nodes including a subject, a predicate and an object. A subject is an RDF URI reference (U) or a Blank Node (B), a predicate is an RDF URI reference (U), and an object is an RDF URI reference (U), a literal (L) or a Blank Node (B). A set of such triples is called an RDF graph. Table 1 shows an example RDF graph structure.

TABLE 1

| Subject | Predicate | Object |
|---|---|---|
| uri://....../rule#CD- | rdf:type, | uri://............/Rule |
| introduction, | | |
| uri://....../rule#CD- | uri://....../rule#assumption, | “c” |
| introduction, | | |

The granularity may be achieved by the basic format of operation (e.g. RDF) within the specific computation environment. Furthermore, the reflectivity of processes (i.e. the capability of processes to provide a representation of their own behavior to be used for inspection and/or adaptation) may be achieved by encoding the behavior of the computation in RDF format. Additionally, the context may be assumed to be partly predetermined and stored as RDF in the information space and partly be extracted from the execution environment. It is noted that the RDF structures can be seen as subgraphs, RDF molecules (i.e., the building block of RDF graphs) or named graphs in the semantic information broker (SIB) of information spaces.

In certain embodiments serializing the closures associated with a certain execution context enables the closures to be freely distributed among multiple UEs 101 and/or devices, including remote processors associated with the UEs 101 by one or more user information spaces 113a-113n via the communication network 105. The processes of closure assigning and migration to run-time environments may be performed based on a cost function as executed by a closure definition module 219, which accepts as input variables for a cost determination algorithm those environmental or procedural factors that impact optimal processing capability from the perspective of the multiple UEs, remote processors associated therewith, information space capacity, etc. Such factors may include, but are not limited to, the required processing power for each process, system load, capabilities of the available run-time environments, processing required to be performed, load balancing considerations, security considerations, etc. As such, the cost function is, at least in part, an algorithmic or procedural execution for evaluating, weighing or determining the requisite operational gains achieved and/or cost expended as a result of the differing closure assignment and migration possibilities. Objectively, the assignment and migration process is to be performed (e.g., by the closure definition module 219) in light of that which presents the least cost relative to present environmental or functional conditions.

It is noted that the serialization module 209 may perform the serialization based on the one or more object models, context models, or the like. In generating the serialization, the serialized computation may reference or integrate specific structured data items, one or more pointers to one or more of the binary or unstructured data items, or a combination thereof. By way of example, a serialization may include a pointer for referencing the location of a specific binary image given its large size, while a serialization of structured data may be more readily integrated for direct replication across nodes. Binding of the serialization by the analytics engine 207 enables the related computation to be presented as a part of the structured data object. Thus it can be presented along with the data object for granular and reflective run-time processing.

In one embodiment, a communication module 211 enables formation of a session over a network 109 between the data analysis platform 103, the various data sources 113 and the one or more nodes 101. By way of example, the communication module 211 executes various protocols and data sharing techniques for enabling collaborative execution between nodes, i.e., UE 101a-101n and the data analysis platform 103 over a distributed communication network 105 (e.g., cloud based infrastructure). It is noted that the communication module 211 is also configured to support application calls or application programming interface requests by various nodes—i.e., the retrieval of data items as referenced by an application operable by a node.

Also, in one embodiment, a controller module 203 is configured to regulate the communication processes between the various other modules for facilitating real-time execution of computations of data based on context information upon collection, storage, retrieval or use of the data. For example, the controller module 203 generates the appropriate signals to control the communication module 211 for facilitating transmission of data over the network 105. Also, while not shown, the controller module 203 may access various monitoring systems for regulating operation of the data analysis platform 103. This may include systems for detecting current data traffic levels, error conditions, data exchange rates, network latencies, resource allocation levels and other conditions associated with the operation of the data analysis platform 103 within the distributed computing environment.

As mentioned, a closure processing module 213 may also be configured to perform computation closure processing of the one or more data items. FIG. 2B is a diagram of a closure processing module 213 of the data analysis platform 103, according to one embodiment. By way of example, the closure processing module 213 includes one or more components for construction and aggregation of distributed computations among nodes within the distributed computing environment. It is contemplated that the functions of these components may be combined in one or more components or performed by other components of equivalent functionality. In this embodiment, the closure processing module 213 includes an execution context determination module 215, an execution context decomposition module 217, a closure definition module 219, a closure serialization module 221, a closure consistency determination module 223, and a closure aggregation module 225, a reflective processing module 227 and a monadic processing module 229.

The closure processing module 213 receives a request for computation distribution. In one embodiment, the request may have been generated by a node 101 or a component of an information space linked to the node, such as by an independent component having connectivity to the information space or cloud via the communication network 105. The request for computation distribution may include information about the computation that is going to be distributed, including input, output, processing requirements, etc. The request may also include information about the origin and the destination of a computation. For example, a user may want to distribute the computations associated with encoding a video file from one format to another (a typically highly processor and resource intensive task). In this example, the video file is stored in the user's information space 115 or otherwise available over the communication network 105 (e.g., downloaded from a source over the Internet), and therefore accessible from the UEs 101. Accordingly, the user may make a manual request to distribute the computations associated with the video encoding to one or more other nodes, a backend server, cloud computing components and/or any other component capable of performing at least a portion of the encoding functions. By way of example, the manual request may be made via a graphical user interface by dragging an icon or other depiction of the computations to command areas depicted in the node user interface. In other cases, the distribution can be initiated by the system 100 based on one or more criteria (e.g., time criticality, data requirements).

In one embodiment, following the receipt of the computation distribution request, the execution context determination module 215 retrieves and analyzes the information regarding the computation and determines the execution components involved in the computation. For the above example (encoding a video file from one format to another), the execution context may include video playing, audio playing, codec formatting, etc., and related settings, parameters, memory states, etc. The identified execution context may be stored in a local storage 231, in a storage space associated with the cloud 119, sent directly to the execution content decomposition module 217, or a combination thereof. It is noted that local storage of the execution context may also correspond to the context database 109a of FIG. 2B.

In another embodiment, the execution context decomposition module 217 breaks each execution context into its primitive or basic building blocks (e.g., primitive computation closures) or the sub-processes of the whole execution context. For example, the video playing execution may be decomposed into computations or processes that support tasks such as, searching for available players, check the compatibility of video file with the players found, select the player, activate the selected player, etc. Each of the decomposed sub-processes may have certain specifications and requirements to effect execution of the processes in an information space or computation space such as input and output medium and type, how parameters or results are to be passed to other processes, runtime environments, etc. In order for a process to be executed in a standalone fashion without being part of a larger process, a computation closure can be generated for the process. A computation closure includes the process and the specifications and requirements associated with the process that can be executed independently for subsequent aggregation.

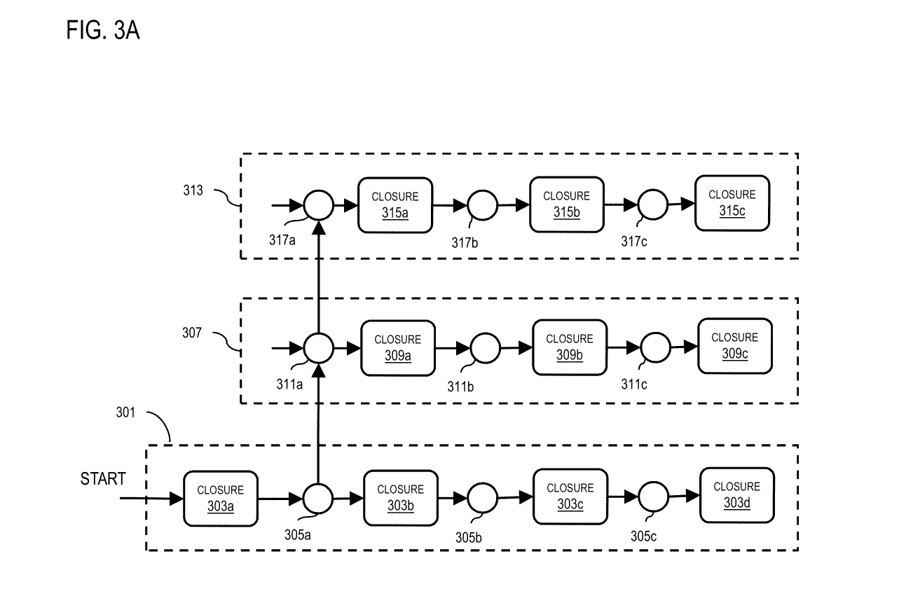

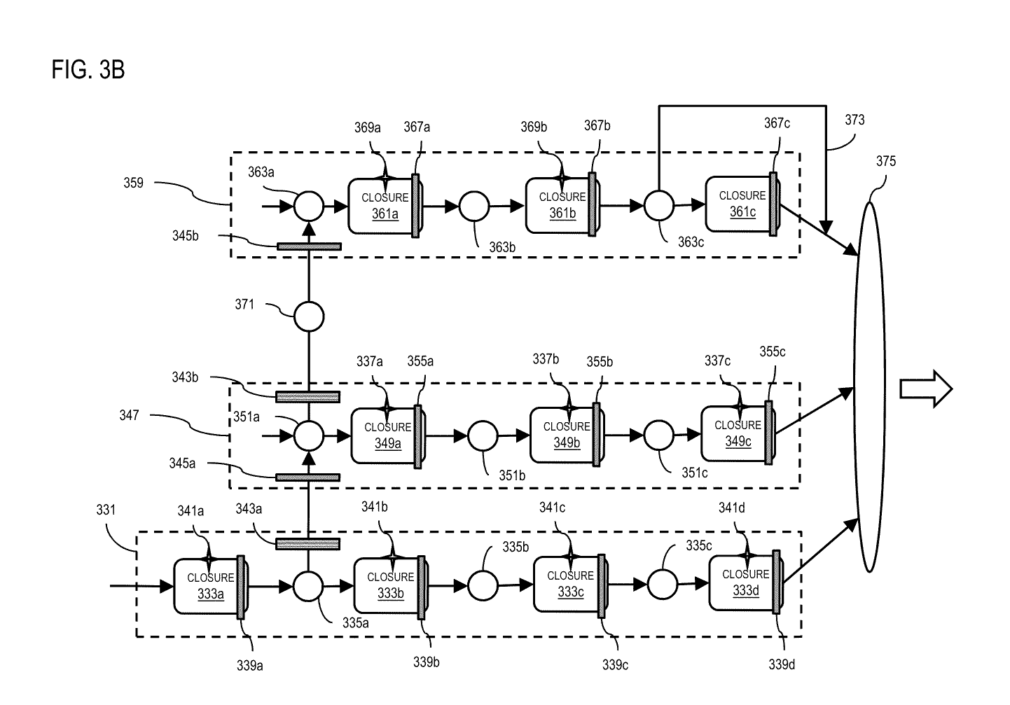

In one embodiment, the closure definition module 219 generates computation closures for the sub-processes extracted by the execution context decomposition module 217 and stores the closures in the database 231. The stored closures may be used for slicing computations into smaller independent processes to be executed by various nodes, using the data which may be stored on the distributed information spaces. Operating in connection with the closure definition module 219, in accord with one embodiment, the monadic processing module 229 enables computation closures to be encoded with specific functional data types based on processing rules that allow them to be chained together, such as to sequence the computation processing or regulate the control flow of computation processing. This process is described in more detail later on with respect to FIGS. 3A and 3B.

Following the migration of each computation closure to its designated run-time environment, the run-time environment may communicate with the closure processing module 213 regarding the receipt of the closures through components referred to as agents. Upon receiving the communication from an agent, closure consistency determination module 223 verifies the consistency of the closures which, as explained before, are in RDF graph format. The consistency verification ensures that the computation closure content for each closure is accurate, contains all the necessary information for execution, the flow of data and instructions is correct according to the original computation and has not been damaged during the serialization and migration process. If the closures pass the consistency check or is otherwise approved, closure aggregation module 225 reconstructs each component of the execution context based on the content of the computation closures. Once an execution context is reconstructed, the agents of the run-time environment can resume the execution of the execution context component that it initially received as computation closures in RDF format. In one embodiment, the resumption of the execution may be combined with one or more other results of other executions of at least a portion of the execution context.

In one embodiment, the execution of a reflective processing module 227 allows the execution context as aggregated by module 225 to be modified dynamically as engaged by the run-time environment. In effect, the reflective processing module 227 monitors and then modifies the execution structure and/or behavior at run-time, such as in response to perceived metadata as encoded within the computation structures as aggregated or other predetermined response data (framework data, relational mapping, object relevancy data for taking advantage of generic code executions, etc.). As such, the reflective processing module 227 tailors the execution to meet specific processing goals. For example, a video data execution intended to be rendered in one format may be adapted at run-time to meet new format requirements.

FIGS. 3A and 3B are diagrams depicting a functional flow of computation closures as distributed across nodes, according to various embodiments. FIG. 3A is a general representation of computation distribution. As seen in FIG. 3A, the computation distribution starts at a component 301 of an architectural level (not shown). Each component may execute a set of closures that constitute a computation branch. For example, the branch 301 is composed of closures 303a-303d, wherein every two consecutive closures are connected via a connector and computational branches are communicating via connectors as well. For example, connectors 305a-305c connect closures 303a-303d. Connectors may also transfer information and data associated with a closure and its execution results to the next closure in the branch or to other branches. Additionally, connectors may function as links between related branches that constitute a distributed computation.

In one embodiment, connectors may contain information about parameters such as security requirement and/or capabilities, functional flows, distribution maps, links between closures and architectural levels, etc. Arrows connecting closures to connectors and connectors to next closures show the functional flow adopted based on the parameters. As seen in FIG. 3A, the closures have been distributed from component 301 to component 307 via communication between connector 305a and connector 311a. The computation branch of component 307 includes closures 309a-309c communicating via connectors 311b and 311c, while branches 301 and 307 communicate via connectors 305a and 311a. Similarly, a third branch 313 has been formed of closures 315a-315c being executed at component 313 and connected by connectors 317b and 317c, while the branch communicates with other branches via connector 317a.

In one embodiment, the initial branch 301 may be in a UE 101, the second branch 307 in a component of the cloud infrastructure 119, and the third branch in another component of the same infrastructure, a different infrastructure, in a different cloud, or a combination thereof.

FIG. 3B shows a computation distribution together with various parameters affecting the distribution. As seen in FIG. 3B, the computation distribution starts at a component 331 of an architectural level (not shown). Each component may execute a set of closures that constitute a computation branch. For example, the branch 331 is composed of closures 333a-333d, wherein every two consecutive closures are connected via a connector and computational branches are communicating via connectors as well. For example, connectors 335a-335c connect closures 333a-333d and connector 371 connects branches 347 and 359. Connectors may also transfer information and data associated with a closure and its execution results to the next closure in the branch or to other branches. Additionally, connectors may function as links between related branches that constitute a distributed computation.

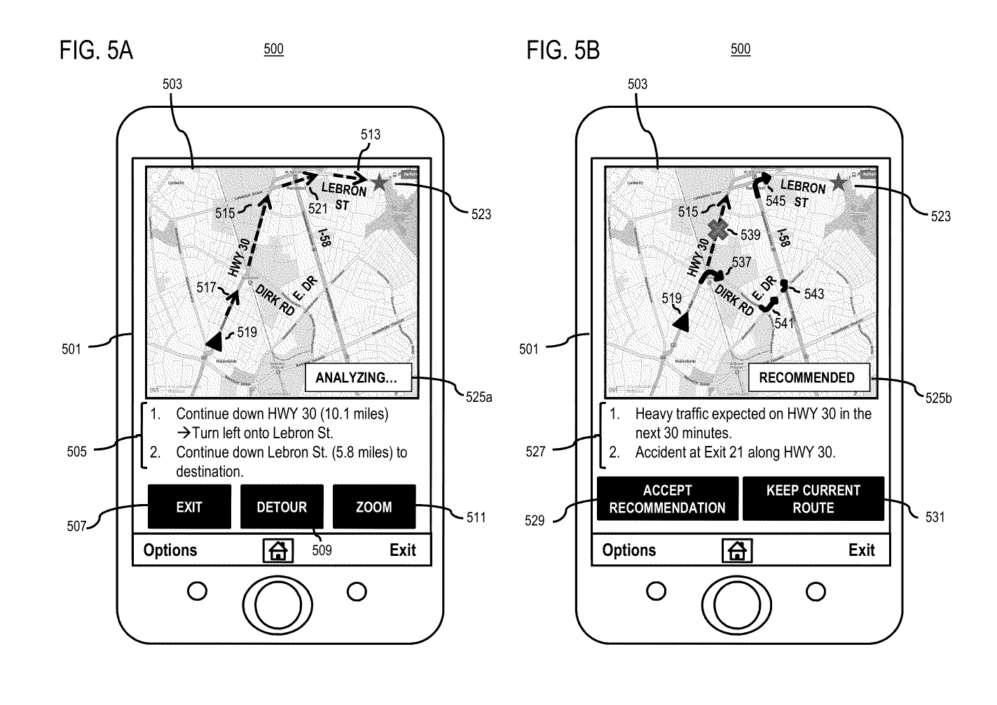

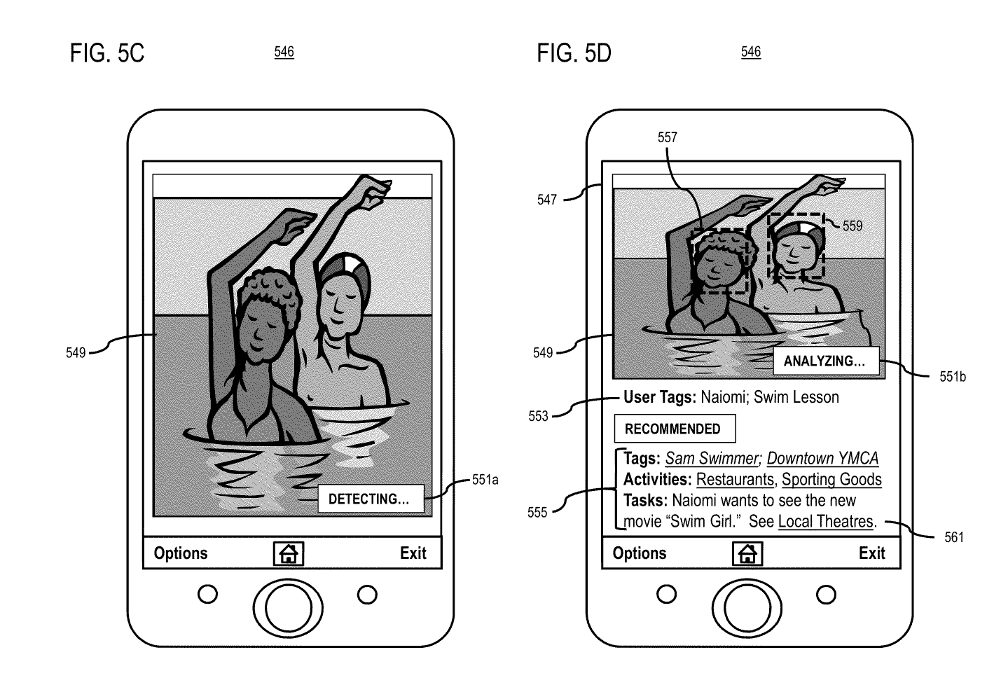

In one embodiment, connectors may contain information about parameters such as capabilities including security requirements and availability, a cost function, functional flow specifications, distribution maps, links between closures and architectural levels, etc. Arrows connecting closures to connectors and connectors to next closures show the functional flow adopted based on the parameters. For example, star signs 341a-341d, 337a-337c, and 369a-369b, represent security rules imposed on the closures and the signs 345a-345b represent the security rules imposed on superclosures by the user of UEs 101, default by the manufacturer of UEs 101, by the cloud 119, or a combination thereof, and associated with each closure 333a-333d, 349a-349c, and 361a-361c respectively. Additionally, blocks 339a-339d, 355a-355c, and 367a-367c represent signatures for one or more closures, and blocks 343a-343b represent supersignatures for one or more superclosures. In the example of FIG. 5B, the signature 339a shows the signature for closure 333a based on the rules 341a. In one embodiment, if signature 339a is in accordance with rules 341, the signature is validated and the closure 333a can be distributed, however if signature 339a contradicts any rule of rules 341a, the closure 333a will be identified as invalid by the authentication module 201.

In one embodiment, the block 343a represents a supersignature composed of a set of signatures 339a-339d and block 345a represents combined security rules of component 347 of the multi-level computation architecture. In this embodiment, if the authentication module 201 detects a contradiction between the supersignature 343a and the rules 345a, the super signature 343a is decomposed into its root elements (e.g. 339a-339d) and the authentication module 201 verifies the root signatures against rules 345a. The verification may lead to finding one or more invalid root elements (e.g. closures 339a-339d).

In one embodiment, a closure or a group of closures may lack access to security rules for the verification of their signatures. For example, in FIG. 3B the closure 361c is signed with signature 367c with no rules. In this embodiment as seen by arrow 373, the authentication module 201 may tag the closure 361c as invalid so that the distributed computation component that is executing branch 359 bypass the closure 361c without executing the computation 361c. The final results from closure execution of the three branches 331, 347 and 359 are aggregated by result aggregator 375 and forwarded to the requesting device.

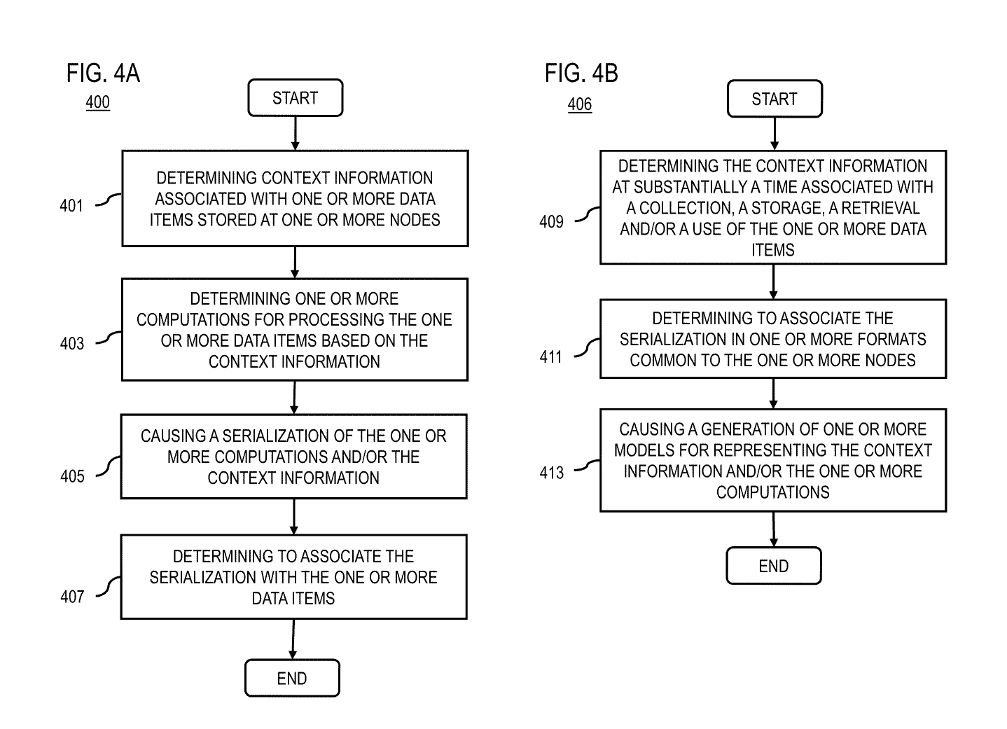

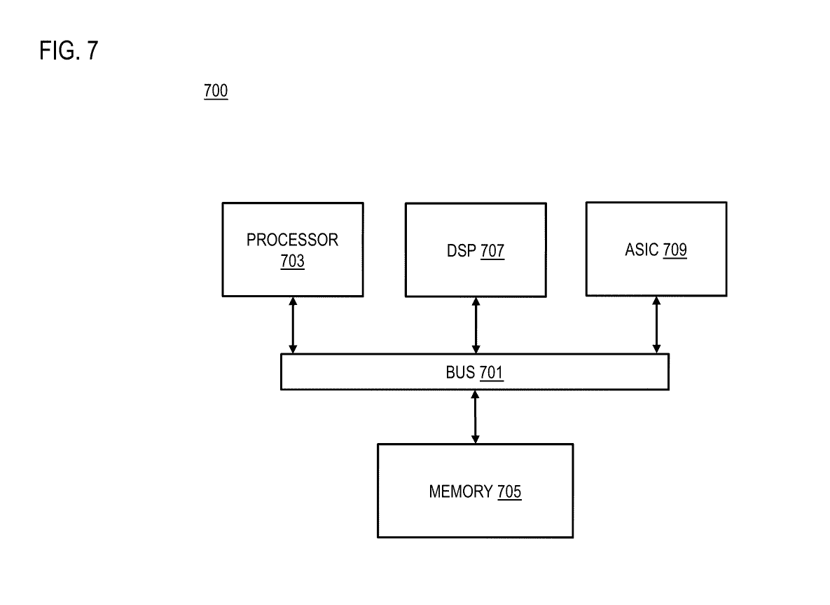

FIGS. 4A and 4B are flowcharts of a process for facilitating real-time execution of computations of data based on context information upon collection, storage, retrieval or use of the data, according to various embodiments. In one embodiment, the data analysis platform 103 performs the process 300 and is implemented in, for instance, a chip set including a processor and a memory as shown in FIG. 7. In step 301, the data analysis platform 103 determines context information associated with one or more data items stored at one or more nodes. In step 303, the context information is used to determine one or more computations for processing the one or more data items. As mentioned previously, the processing is carried out based on one or more context models, data analysis models or the like for facilitating context processing, computation closure processing, etc. Furthermore, the context information includes, at least in part, one or more business contexts, one or more situational contexts, one or more processing rules, or a combination thereof associated with the one or more data items, the one or more nodes, one or more devices associated with the context information, or a combination thereof.

Per step 405, the data analysis platform 103 causes a serialization of the one or more computations and/or the context information. As mentioned previously, the serialization of the computation of the one or more data items is associated with, or performed according to, one or more formats common to the one or more nodes that may access the serialization for run-time execution. In another step 407, the platform 103 determines to associate the serialization with the one or more data items. By way of this association, when one or more nodes access the one or more data items—i.e., retrieve, store, collect or otherwise use—the serialized computation is conveyed for enabling real-time or near-real time execution of the associated computations.

In step 409 of process 406 (FIG. 4B), the data analysis platform 103 determines the context information at substantially a time associated with a collection, a storage, a retrieval and/or use of the one or more data items. As mentioned previously, processing context information concurrent with the accessing of the one or more data items facilitates real-time or near real-time execution of processing tasks related to the data items. By way of example, the context information is used by the platform 103 to perform analysis of the data items and enable computation closure processing; such that the resulting computations may render the one or more data items for the given context as immediately actionable rather than at a later time of processing.

In step 411, the platform 103 determines to associate the serialization of the one or more computations for processing of the one or more data items in one or more formats common to the one or more nodes. As mentioned with respect to the preceding step 409, serializing the one or more computation closures further enhances the immediate usability and actionable capacity of the data items for a given context by the one or more nodes receiving the data items. By way of example, a first node having a first spreadsheet application may require a data table and associated computations thereof to conform to a format suitable for the first spreadsheet application. Consequently, the serialized computations must accommodate the first spreadsheet application, including format, syntax and semantic requirements as well as application programming interface (API) instructions, processing rule formats, dynamic link structures, etc. The same computation for the data table, however, may conform to a format suitable for a second spreadsheet application for a second node that requires execution, operation or processing of the same data items and related computations. It is noted that the serialization may include reference to or integration of structured data (e.g., small images), one or more pointers, or a combination thereof.

Per step 413, the data analysis platform 103 causes a generation of one or more models for representing the context information and/or the one or more computations. By way of example, the models may be generated based on an initial processing of the data items or a refinement of the models may be generated based on a subsequent processing of the data items. As mentioned with respect to the context information processing module 205 of the data analysis platform 103, a deletion of or addition to a data item within the computation space or cloud 119 may be translated accordingly across nodes. Similarly, an updated computation, context model or processing rule, is translated across nodes for ensuring computation consistency.

FIGS. 5A-5D are diagrams of user interfaces utilized in the processes of FIGS. 3A and 3B, according to various embodiments. For the purpose of illustration, the diagrams are described with respect to an exemplary use case of a user device, or node, interacting with one or more data sources within an information space, cloud computing environment, etc. In particular, FIGS. 5A and 5B present a scenario wherein the node requires access to and execution of computations related to structured data items, while FIGS. 5C and 5D pertain to the accessing of and execution of computations related to unstructured (e.g., binary) data items.

In FIGS. 5A and 5B, a user of a mobile device 500 featuring a route planning application is employing the application to access travel directions. The route planning application is configured to acquire data from various data sources, including one or more computation spaces, clouds, etc., for generating route and coordinate data based on the user's current location, intended destination, etc. Data sources and types may vary, and may include for example, traffic data, road condition data, weather data, event data, pedestrian/other user provided data, etc. In addition, the node may be configured to interact with the various data sources, including other nodes, by way of the data analysis platform 103 of FIG. 1.

The application may cause generation of map data to a display 501 of the node for enabling presentment of a map 503 of varying granularity. The perspective or granularity of the map 503 may be adjusted by selecting a “ZOOM” action button 511. Alternatively, the user may select “EXIT” or “DETOUR” action buttons 507 and 509 respectively to exit the application and thus end further requests for data or to alter a determined route to a destination. Various icons, graphics and identifiers may be presented in association with the map for depicting various instructions or routes to be executed by the user. This may include, for example, one or more route markers 513, 515, 517 and 521 for indicating a direction of travel to be pursued by the user for reaching the final destination 523, a current location marker 519, a final destination marker 523 and other route, traffic or path related details. The current location marker 519 indicates the current path of travel of the user along HWY 30, and one or more instructions 505 are presented for directing the user along the recommended route.

By way of the example, the data analysis platform 103 enables the mobile device to perform one or more computations of the data based on context information, the data items provided by the various data sources, or a combination thereof. Under this scenario, predictive analysis may be performed in order to determine that the traffic relevant to the recommended path of travel will deteriorate in the next 30 minutes. This prediction may be based, at least in part, on the stream of data items being retrieved, stored, collected or otherwise used (e.g., current and/or historical accident data, road condition data, event data). In addition, context information including present time and date data, speed data, vehicle condition data (e.g., the mobile device is synchronized with a fuel sensor of a vehicle) can be analyzed to determine that it is currently a peak time for traffic (e.g., a Friday afternoon).

As such, real-time processing of the data items can be performed concurrent with accessing of the data to generate the prediction. Processing is facilitated by way of computation closure processing of the data items, including analyzing the data items based on various traffic and/or route mapping algorithms, with the resulting computations being based in part on the determined context information. A status indicator 525a is presented to indicate a current data item processing status as “ANALYZING . . . ”

The resulting computations are then serialized, and associated with the data items. Under this scenario, for example, one or more revised instructions 527 may be caused to be generated and displayed via the display 501. The instructions may include details for indicating the specific basis, or context for the recommendation, a description of the updated route to be taken, etc. In addition, execution of one or more computations may cause the generation of updated route data to be presented to the map 503, as shown in FIG. 5B. The corresponding route markers 537, 541, 543 and 545 correspond to an alternate route to the final destination 523 by way of HWY 30, DIRK RD., I-55 and LEBRON ST. In addition, a cancellation marker 539 is shown with respect to the original route marker 515 for indicating a path of travel along HWY 30 to LEBRON ST. A status indicator 525b is presented to indicate a current data item processing status of “RECOMMENDED,” i.e., for indicating the current view is a real-time recommendation view.

One or more action buttons may be presented to the user for supporting the execution, including an “ACCEPT RECOMMENDATION” action button 529 for allowing the user to indicate acceptance of the recommended alternate route. A “KEEP CURRENT ROUTE” action button 531 may also be selected for enabling the user to maintain the current route. It is noted that the recommendation is the result of the processing of the one or more serialized computations as execute at the device. Other executions, including automated processes, alerts, communication tasks, and other processing tasks relevant to the one or more data items may be The context information, therefore, guides the usage and priority of execution of a particular computation relative to the various traffic data, weather data and other data items collected.

In FIGS. 5C and 5D, a user of a mobile device 546 featuring an integrated camera device snaps a picture of a friend engaging in a swimming lesson at a local YMCA. For example, in FIG. 5C, the image data is captured by the device in unstructured (binary) form. Concurrent with the snapping of the picture 549 (or prior to), the data analysis platform 103 enables context information pertaining to the device, user of the device or other users interacting with the device to be gathered. For example, geospatial data is generated as location information for detecting the presence of the user/device at a local YMCA. A status indicator 551a is presented to the display to indicate the detection process is underway.

In FIG. 5B, an analysis process is depicted. For example, in connection with the image acquisition and context information detection process, the analytics engine of the data analysis platform 103 executes pattern recognition of the image data 549 to match it against other known image data. Pattern recognition analysis is performed based on the context information generated by the device (e.g., location data) as well as user tag data 553 provided explicitly by the user. The context information as detected and tag information as provided enable both implicit and explicit analysis of the image data to be performed. By way of example, the location information for the YMCA and tag for indicating “Swim Lesson” (as entered by a user) may be processed, in the form of one or more serialized computations, to direct/restrict the image matching to those featured in the YMCA website or at select social networking sites. In addition, current time data may be compared against available YMCA staff schedule data to deduce which instructors correspond to the “Swim Lesson” activity. A status indicator 551b is presented to indicate a current data item processing status of “ANALYZING,” i.e., for indicating pattern recognition of a first and second subject 557 and 559 respectively is underway in real-time.

Based on this analysis, swim instructor Sam Swimmer corresponding to the second subject 559 is identified—i.e., image data successfully matched against online YMCA staff profile images of the instructor and current time data corresponds to the regular work hours of the instructor as posted on the staff profile page. Also, the nodes are caused to generate various recommendations 555 to be executed by the device 546 pursuant to the processing of one or more serialized computations of the various data items, context information, or a combination thereof. For example, tags “Sam Swimmer” and “Downtown YMCA” are offered corresponding to the instructor's name and specific location of the YMCA respectively. The user can select a tag by way of touch screen input or other input means.

In addition, activity based recommendations such as local restaurants or local sporting goods stores within the vicinity of the YMCA are caused to be presented per one or more computations of the image data and/or context information. In the case of the local restaurants, the information may be gathered based in part on location information, time data (e.g., impending lunch time) and user profile information (e.g., preferred meal or restaurant types). Still further, a task recommendation may be generated and caused for presentment to the display 547 based on the provided tag “Naiomi,” pattern recognition of the image data of the first subject 557 against social networking sites or cloud data servers, historical data indicating the interaction of the user and the subject (Naiomi) during the current time of the day, etc. Under this scenario, theatres within proximity of the YMCA (present location of the user) are presented based on the determination that the image data corresponds to the friend, whose social networking profile indicates their desire to see a movie entitled “Swim Girl.” The user may select a “Local Theatres” link 561 to access the information.

It is noted that the image analysis may be restricted to the social networking sites frequented by the user. Furthermore, data access for certain computations may be limited to only those friends to which the user has a frequency of correspondence—i.e., only those friends interacting within a common information space. Hence, computation closure processing is performed based on a sub-set of available data to increase processing speed as well as fine-tune determinative results.

It is further noted, with respect to the exemplary embodiments described above, that user provided context data entry enables explicit analysis to be performed. The context data acquired by way of the one or more sensors of the device (e.g., for gathering location information) enables implicit analysis of the image data. As such, one or more computations may be generated based on the user provided data or sensor gathered data, including processing of the explicit data by way of one or more context models

The exemplary system and techniques presented herein enables substantially real-time execution of context specific computations relative to the accessing of one or more data items within a cloud/computation space environment. By associating a serialized form of a computation for processing of the one or more data items with the data items, the value of the data may be exploited to fulfill business, situational or other processing needs. It is noted that the system enables data items of varying granularity to be stored concurrent with performance of in-node processing and analytics to account for varying contextual circumstances.

The processes described herein for facilitating real-time execution of computations of data based on context information upon collection, storage, retrieval or use of the data may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

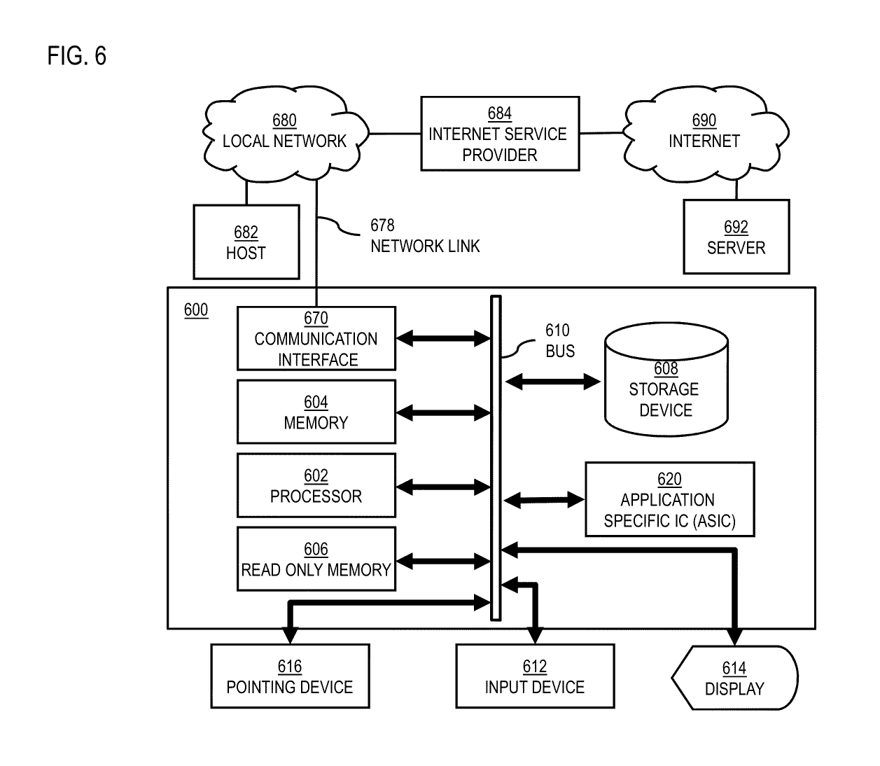

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to facilitate real-time execution of computations of data based on context information upon collection, storage, retrieval or use of the data as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of facilitating real-time execution of computations of data based on context information upon collection, storage, retrieval or use of the data.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to facilitate real-time execution of computations of data based on context information upon collection, storage, retrieval or use of the data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for facilitating real-time execution of computations of data based on context information upon collection, storage, retrieval or use of the data. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for facilitating real-time execution of computations of data based on context information upon collection, storage, retrieval or use of the data, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for facilitating real-time execution of computations of data based on context information upon collection, storage, retrieval or use of the data to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to facilitate real-time execution of computations of data based on context information upon collection, storage, retrieval or use of the data as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of facilitating real-time execution of computations of data based on context information upon collection, storage, retrieval or use of the data.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to facilitate real-time execution of computations of data based on context information upon collection, storage, retrieval or use of the data. The memory 705 also stores the data associated with or generated by the execution of the inventive steps.

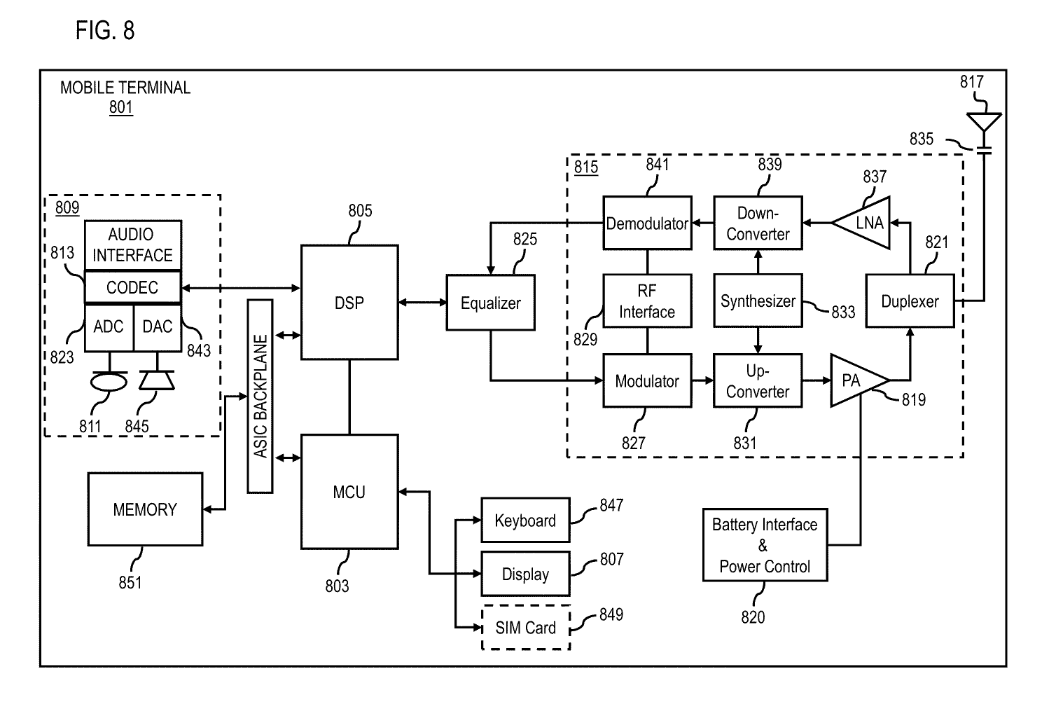

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of facilitating real-time execution of computations of data based on context information upon collection, storage, retrieval or use of the data. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of facilitating real-time execution of computations of data based on context information upon collection, storage, retrieval or use of the data. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to facilitate real-time execution of computations of data based on context information upon collection, storage, retrieval or use of the data. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining context information associated with one or more data items stored at one or more nodes;
determining one or more computations for processing the one or more data items based, at least in part, on the context information;
causing, at least in part, a serialization of the one or more computations, the context information, or a combination thereof; and
determining to associate the serialization with the one or more data items.

2. A method of claim 1, wherein the context information includes, at least in part, one or more business contexts, one or more situational contexts, one or more processing rules, or a combination thereof associated with the one or more data items, the one or more nodes, one or more devices associated with the context information, or a combination thereof.

3. A method of claim 2, further comprising:
processing and/or facilitating a processing of the serialization, the one or more data items, the context information, or a combination thereof to cause, at least in part, an execution of at least one of the one or more computations.

4. A method of claim 3, wherein the processing is caused to be performed at at least one of the one or more nodes.

5. A method of claim 3, wherein the processing is caused to be performed in substantially real-time with respect to a collection, a storage, a retrieval, a use, or a combination thereof of the one or more data items.

6. A method of claim 1, further comprising:
determining the context information at substantially a time associated with a collection, a storage, a retrieval, a use, or a combination thereof of the one or more data items.

7. A method of claim 1, wherein the serialization is associated with the one or more data items via structured data, one or more pointers, or a combination thereof.

8. A method of claim 1, further comprising:
determining to associate the serialization in one or more formats common to the one or more nodes.

9. A method of claim 1, wherein the one or more data items include, at least in part, structured data, unstructured data, binary data, or a combination thereof.

10. A method of claim 1, further comprising:
causing, at least in part, a generation of one or more models for representing the context information, the one or more computations, or a combination thereof,
wherein the serialization is based, at least in part, on the one or more models.

11. An apparatus comprising:
at least one processor; and
at least one memory including computer program code for one or more programs,
the at least one memory and the computer program code configured to, with the at least one processor, cause the apparatus to perform at least the following,
determine context information associated with one or more data items stored at one or more nodes;
determine one or more computations for processing the one or more data items based, at least in part, on the context information;
cause, at least in part, a serialization of the one or more computations, the context information, or a combination thereof; and
determine to associate the serialization with the one or more data items.

12. An apparatus of claim 11, wherein the context information includes, at least in part, one or more business contexts, one or more situational contexts, one or more processing rules, or a combination thereof associated with the one or more data items, the one or more nodes, one or more devices associated with the context information, or a combination thereof.

13. An apparatus of claim 12, wherein the apparatus is further caused to:
process and/or facilitate a processing of the serialization, the one or more data items, the context information, or a combination thereof to cause, at least in part, an execution of at least one of the one or more computations.

14. An apparatus of claim 13, wherein the processing is caused to be performed at at least one of the one or more nodes.

15. An apparatus of claim 13, wherein the processing is caused to be performed in substantially real-time with respect to a collection, a storage, a retrieval, a use, or a combination thereof of the one or more data items.

16. An apparatus of claim 11, wherein the apparatus is further caused to:
determine the context information at substantially a time associated with a collection, a storage, a retrieval, a use, or a combination thereof of the one or more data items.

17. An apparatus of claim 11, wherein the serialization is associated with the one or more data items via structured data, one or more pointers, or a combination thereof.

18. An apparatus of claim 11, wherein the apparatus is further caused to:
determine to associate the serialization in one or more formats common to the one or more nodes.

19. An apparatus of claim 11, wherein the one or more data items include, at least in part, structured data, unstructured data, binary data, or a combination thereof.

20. An apparatus of claim 11, wherein the apparatus is further caused to:
cause, at least in part, a generation of one or more models for representing the context information, the one or more computations, or a combination thereof,
wherein the serialization is based, at least in part, on the one or more models.
